(19) United States
(12) Patent Application Publication
(10) Pub. No.: US 2009/0112666 A1
(43) Pub. Date: Apr. 30, 2009

(54) APPARATUS AND METHOD FOR GENERATING A MONITORING VIEW OF AN EXECUTABLE BUSINESS PROCESS

(76) Inventors: Chang Jie Guo, Beijing (CN); YI Hui, Beijing (CN); Jun Jie Nan, Beijing (CN); Tie Jun Ou, Beijing (CN); Wei Sun, Beijing (CN); Zi Yao Wang, Beijing (CN); Weixin Xu, Union City, CA (US); Yu Zhang, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/260,121

(22) Filed: Oct. 29, 2008

(30) Foreign Application Priority Data
Oct. 31, 2007 (CN) 200710167037.3

(51) Int. Cl. G06Q 99/00

(52) U.S. Cl. 705/7

(57) ABSTRACT

A method and apparatus for generating a monitoring view of an executable business process. The method comprises the steps of: obtaining a business process model from an executable business process template; generating a business process monitoring model from the business process model; obtaining status data of a business process instance from a business process engine; generating a business process monitoring model instance by combining the status data with the business process monitoring model; and presenting the business process monitoring model instance as a monitoring view for a user to monitor a running business process instance. The apparatus includes hardware for accomplishing the foregoing method steps.

### CROSS-REFERENCE TO RELATED APPLICATIONS

This application claims priority under 35 U.S.C. §119 from Chinese Patent Application No. 200710167037.3 filed Oct. 31, 2007, the entire contents of which are incorporated herein by reference.

### BACKGROUND OF THE INVENTION

1. Field of the Invention

The present invention relates to the computer field, particularly to the business process management field, and more particularly to an apparatus and method for generating a monitoring view of an executable business process.

2. Description of the Related Art

Executable Business Process (xBP) technologies are being adopted by more and more enterprises to automate their Enterprise Business Processes (eBP). An xBP is a kind of eBP whose lifecycle is controlled by a system called Business Process Management System (BPMS). Usually, an xBP is long running, with its running period spanning days, months or years. An xBP relies on specific interactions between users, systems and business partners which it ties together. One of the well-known xBP technologies is Business Process Execution Language (BPEL), and there are many other xBP technologies in addition to BPEL, such as Web Services Flow Language (WSFL) and Web Services for Business Process Design (XLANG). Different BPMS software vendors support/leverage certain xBP technologies.

xBP technologies usually need to handle many IT system level details, which include interaction protocols (e.g. HTTP, SOAP, JMS, JCA) with different systems, process related data structures (e.g. XML message type) and mapping rules among data, business rules and flow control (e.g. condition expressions expressed by specific language like Xpath), and more. So an xBP is usually developed by a programmer and then deployed onto a BPMS system. It can hardly be understood by a business user as it contains too many IT details. However, as an xBP is used to automate business processes, business users have strong demand to understand what is going on about the business processes in which they are involved. That is to say, business users have the need to intuitively monitor the execution status of an xBP which is running in a BPMS system.

Most BPMS software vendors provide certain monitoring capability for an xBP deployed on a BPMS. However, the monitoring capability is on an IT level and can only be easily understood by IT people (e.g. system administers). For example, IBM WebSphere Process Server (WPS) provides a capability called “BPC Explorer” which can only show the execution status of the BPEL processes running on the WPS. However, since BPEL was not originally designed for the purpose of process monitoring by end business users, this capability cannot provide an intuitive and overall view. Business users can hardly map BPEL (xBP processes) to an eBP they really understand on business level. Most BPMS software has a similar problem.

There are some efforts in the art which try to solve the same or related problems. Some BPMS software vendors are trying to solve the problem through a Model Driven Business Process Development approach. According to this approach, an eBP should be defined by a business analyst first, and then the eBP will be transformed into an xBP for IT implementation. However, this approach has the following challenge which makes this approach hardly satisfy user requirements. In most cases, an eBP can hardly maintain very good round-trip traceability with an xBP. An eBP cannot be simply one to one mapped to an xBP. Even if an eBP can be transformed into an xBP, the xBP will usually be customized by a programmer for IT implementation, and this customization can hardly be mapped back to the eBP programmatically. So today, an xBP can not be automatically mapped to an eBP to serve business users' monitoring requirements, and an eBP for business process monitoring should be generated manually, which makes the development and management of business level process monitoring complex and costly.

For example, IBM further provides the WebSphere Business Monitor for event based process monitoring, which can show a business operation model (BOM)-based monitoring UI. Its shortcoming, however, is a developer/designer needs to use great effort to build a complex monitoring model manually, thus there is a long monitoring model building/testing/deployment lifecycle. In addition, the BOM model is also IT oriented, instead of business user oriented.

For another example, U.S. patent application US20060106626, entitled “Method and apparatus of model driven business solution monitoring and control”, provides a method for transforming a business level model to an IT level executable BPEL language by applying model driving and additionally sending various events and data by a process engine to monitor a process. The method needs to construct a complex model manually.

Therefore, in the technical field there is a need for a development and management solution for business process monitoring that can overcome or alleviate the above shortcomings.

### SUMMARY OF THE INVENTION

According to an aspect of the present invention, a method of generating a monitoring view of an executable business process is provided. The method includes the steps of: obtaining a business process model from an executable business process template; generating a business process monitoring model from the business process model; obtaining status data of a business process instance from a business process engine; generating a business process monitoring model instance by combining the status data with the business process monitoring model; and presenting the business process monitoring model instance as a monitoring view through which a user monitors a running business process instance.

According to another aspect of the present invention, an apparatus for generating a monitoring view of an executable business process is provided. The apparatus includes: a monitoring model editor which is configured to obtain a business process model from an executable business process template and generate a business process monitoring model from the business process model; and a visual monitoring dashboard which is configured to obtain status data of a business process instance from a business process engine, generate a business process monitoring model instance by combining the status data with the business process monitoring model and present the business process monitoring model instance as a monitoring view through which a user monitors a running business process instance.

These embodiments have the following characteristics and advantages.

First, these embodiments have a fast and low-cost monitoring development lifecycle. In many cases, there are over 100 process modules needing to be deployed, and the number will be continuously increasing with business growth. Therefore, users wish the time of developing the monitoring model for a new BPEL process should be as short and cost-effective as possible, in order to meet the continuously changing requirements. These embodiments greatly release the development burden on an xBP developer for process monitoring. The xBP developer need not redevelop or substantially modify an xBP or develop a complex monitoring model, and only needs to add a few annotations into the xBP when necessary.

Second, these embodiments allow business users to customize the look and feel of a monitoring view in a self-service and dynamic manner. Although business users usually have very low or even no IT skills, they strongly wish they can customize a monitoring UI at runtime by themselves easily and quickly without recourse to the IT department or software vendor. These embodiments significantly improve the customization capability of process monitoring in terms of user interface, without affecting the xBP's implementation. As the customization can be conducted by an end user at runtime, this greatly decreases the time period of building/customizing monitoring features for business users. This customization process is WYSIWYG, and does not interrupt the running of the business process (i.e., no need of redeployment, restart and stop). And legacy processes can be monitored in a non-intrusive way. Since a process monitoring UI (including the look and feel, and functional extension) can be customized by a user, this greatly improves the user experience of a business user.

Third, these embodiments can provide an intuitive, interactive, and integrated management UI to improve accessibility. These embodiments provide a user with functions supporting its daily use. For example, the user can see more detailed process tracking information on a visual monitoring dashboard, including the process execution path, activity status, roles and business objects (BOs), and navigate smoothly among the main process and its sub-processes. The user can also integrate richer management (e.g. suspend and terminate a process) and collaboration functions (e.g. Email, SMS and IM) into the dashboard to better control the monitored process/activity instances.

Forth, these embodiments are easily integrated and extended. These embodiments can integrate or mix up monitoring features with users' other (third-party) business applications to more fully leverage the monitoring dashboard's strong presentation and interaction capabilities. For example, the monitoring dashboard can guide a user to navigate among different process artifacts to perform a complicated configuration or other business operations. And, such navigation is very easy and effortless.

Finally, these embodiments reduce the cost for enhancing a BPMS to support process monitoring by a business user because the apparatus of the present invention can be implemented as an add-on component of a BPMS not involving changes to the BPMS architecture.

### BRIEF DESCRIPTION OF THE DRAWINGS

The attached claims describe novel features believed to be characteristic of the present invention. However the invention itself and its preferred embodiments, additional objectives and advantages can be best understood from the following detailed description of the illustrative embodiments when read in conjunction with the drawings, in which:

FIG. 1 shows a schema of a monitoring model in XML format according to an embodiment of the present invention;

FIG. 2 shows an exemplary human task object named Avatar and its display manner;

FIG. 3 shows an exemplary automatic task object named Avatar and its display manner;

FIG. 4 shows an exemplary sub-process object named Avatar and its display manner;

FIG. 5 shows an exemplary business object named Avatar and its display manner;

FIG. 6 shows an exemplary link object named Avatar and its display manner;

FIG. 7 shows various types of logical node objects and their display manners;

FIG. 8 shows an example of a dependency relationship between status transitions of monitoring objects.

FIG. 9 shows an apparatus for generating a monitoring view of an executable business process according to an embodiment of the present invention;

FIG. 10 shows whether various nodes in a BPEL model will appear in a monitoring model to be generated according to an embodiment of the present invention;

FIG. 11 shows an example of simplifying an exemplary BPEL model using the method according to an embodiment of the present invention;

FIG. 12 shows a method for processing a container node containing task nodes in a BPEL model according to an embodiment of the present invention;

FIG. 13 shows an exemplary process of changing a task node, which is a non-leaf node represented by a piece of exemplary XML code, of an exemplary BPEL model into a leaf node according to an embodiment of the present invention;

FIG. 14 shows an exemplary process of generating task node paths and a new tree from an exemplary BPEL model fragment according to an embodiment of the present invention;

FIG. 15 shows an exemplary process of promoting a container node in an exemplary BPEL model tree fragment according to an embodiment of the present invention;

FIG. 16 shows an exemplary process of promoting a leaf node in an exemplary BPEL model tree fragment according to an embodiment of the present invention;

FIG. 17 shows an exemplary method for determining task nodes in a Sequence container and a Flow container in an exemplary BPEL model tree formed through the simplification according to an embodiment of the present invention;

FIG. 18 shows an exemplary process of obtaining the source and target nodes of the task nodes in a container in an exemplary BPEL model tree formed through the simplification via their parent container according to an embodiment of the present invention;

FIG. 19 shows a UI in which an editor of a visual monitoring model generated is shown according to an embodiment of the present invention;

FIG. 20 shows a method for collecting status data of an BPEL instance from a BPEL engine according to an embodiment of the present invention; and

FIG. 21 shows an example of a UI of a monitoring object model instance generated according to an embodiment of the present invention.

### DETAILED DESCRIPTION OF PREFERRED EMBODIMENTS

Embodiments of the present invention will be explained hereinafter. It should be understood, however, that the present invention is not limited to the specific embodiments described herein. On the contrary, it is contemplated to implement or practice the present invention using any combination of the following features and elements, regardless of whether they involve different embodiments. Therefore, the following aspects, features, embodiments and advantages are only for illustration and should not be regarded as elements or definitions of the attached claims, unless indicated explicitly in the claims.

The embodiments can automatically extract human tasks and invoke nodes from a running business process, and transform them to a monitoring model at runtime. It significantly releases the development burden on developers for process monitoring. In addition, all the process status data are extracted automatically via a process engine API without needing to insert any additional code into the process template. Further, process status data, including the statuses of human tasks and automation tasks, the execution paths, BOs, roles, etc., are dynamically presented with a pre-generated monitoring model in a visualized way, and the developer need not write any code.

The embodiments further provide a monitoring model editor for further customizing the monitoring model, and the display thereof, without needing to modify, re-deploy, and re-start the underlying BPEL process. In addition, the solution of the present invention can track and manage process instances using an intuitive and interactive visual monitoring dashboard. Task claim, complete and process suspend, terminate functions are provided to manage the process instances. Notification mechanisms like SMS, email and IM are provided to afford the collaboration among business rules.

The technical solution of the present invention is described in detail below with reference to the drawings. The following description is given with respect to a system adopting BPEL. However, both the apparatus and method of the present invention are applicable not only to the system adopting BPEL, but also to a BPMS system adopting any other xBP technologies such as WSFL and XLANG.

### Business Process Monitoring Model

The business process monitoring model according to an embodiment of the present invention comprises all the information necessary for building a graphic monitoring application within a browser. The monitoring model is generated by performing the following operations to extract necessary information from the BPEL model of a deployed or non-deployed business process to be monitored by a monitoring model editor 101 according to an embodiment of the present invention to be described below, obtained by further optional customization and editing of the presented monitoring model by the user in the monitoring model editor 101 to be described below, and instantiated by acquiring its status data from the BPEL engine by a visual monitoring dashboard 102 according to an embodiment of the present invention to be described below. In order to generate a monitoring model from a BPEL model, the BPEL model should contain the following information:
For a process: template ID; and parent process template ID, if available.
For a sub-process: node display name; node ID; node type; associated sub-process template ID; incoming node IDs; and outgoing node IDs.
For a human task: node display name; node ID; node type; incoming node ID; and outgoing node ID.
For an automatic task: node display name; node ID; node type; incoming node ID; and outgoing node ID.
For a logic node (while, decision, fork, join, merge): node display name; node ID; node type; incoming node ID; and outgoing node ID.

In most cases, a BPEL model will contain the above information. So the monitoring model editor 101 of the present invention can generate a monitoring model from a deployed or non-deployed BPEL model to be monitored directly. When a specific BPEL model does not contain some of the above information, the information needs to be added into the BPEL model in the form of annotations before the deployment of the BPEL model, thus the monitoring model editor 101 of the present invention can generate a monitoring model based on the information.

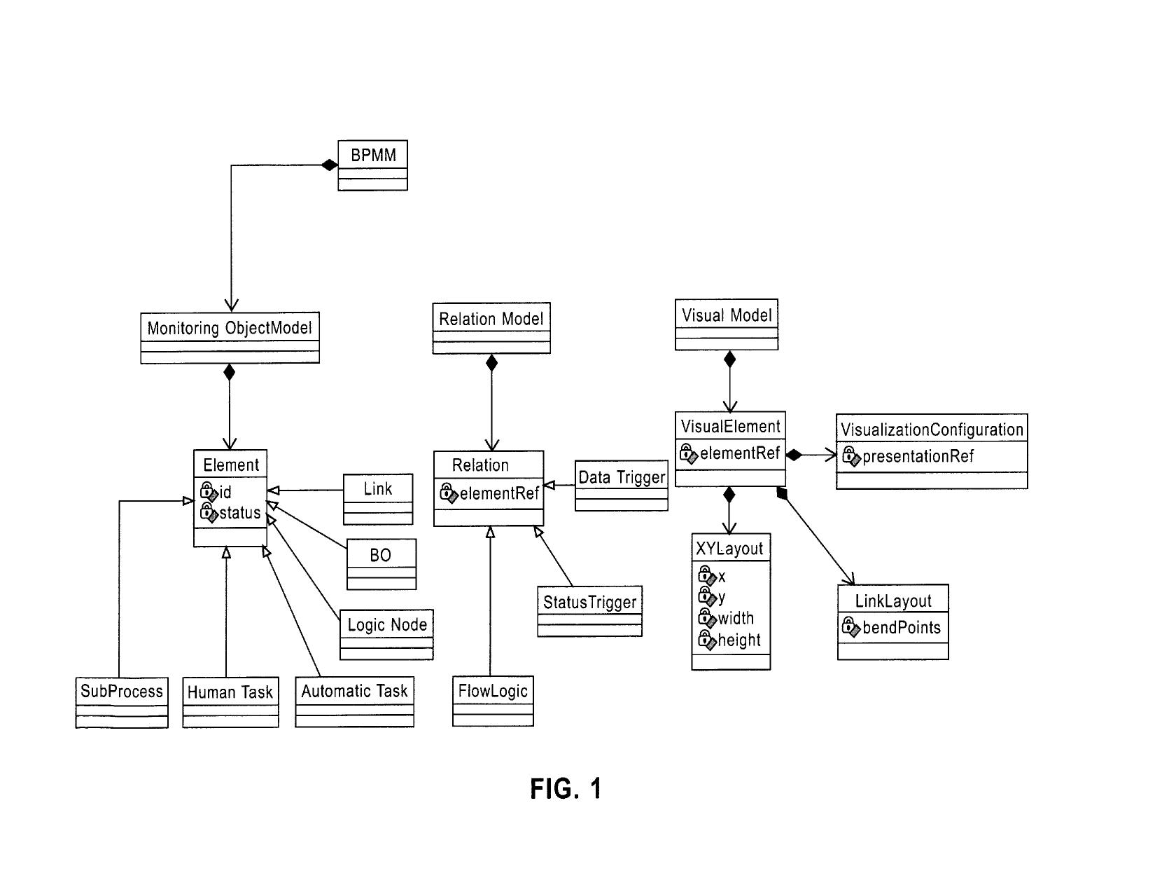

FIG. 1 shows a schema of a monitoring model in XML format according to an embodiment of the present invention. As shown in the figure, the monitoring model comprises a monitoring object model, a relationship model and a visualization model. The monitoring object model specifies monitoring objects that can be included in the monitoring model, the relationship model specifies the relationships among the monitoring objects, and the visualization model specifies the dynamic and automatic visualization rules, i.e. display manners of the monitoring objects.

The monitoring object model comprises the following 5 monitoring objects: human task, automation task, sub-process, BO object and link and logic nodes.

Specifically, key properties of a human task object include:
Object ID;
Object status, including Inactive, Ready, Claimed, Finished, Exception, etc.;
Displayed object name;
Owners' names and contact information (such as IM/SMS/email/Phone Addresses, etc.); and
Input/output BOs, such as business data involved in the human task.

Dynamic or automatic visualization rules of a human task object include:
Dynamically change the picture of the object at runtime according to the object status, such as by using default or pre-defined pictures;
Dynamically associate the object with the owners' pictures according to the object status; Dynamically display the owners' names and contact information near the object; and Dynamically build and display a navigation link and display label to a related BO.

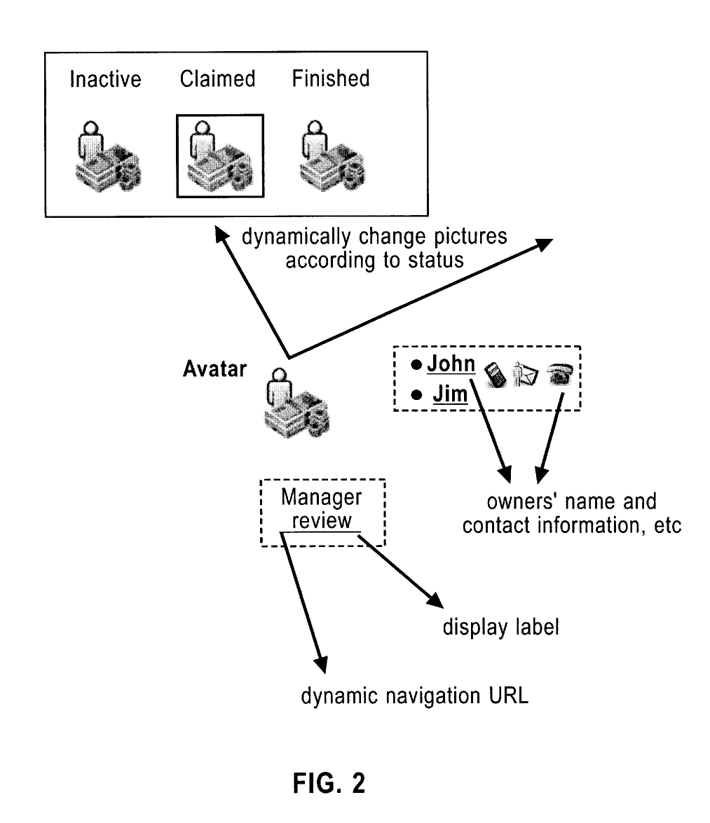

FIG. 2 shows an exemplary human task object named Avatar and its display manner. As shown in the figure, the display manner of the exemplary human task object is to: display the name of the human task object (such as Avatar) and its icon, which will change according to the status of the human task object (such as “Inactive”, “Claimed” and “Finished”); display the pictures, names (such as “John” and “Jim”) and contact information of the owners of the human mask object, which will change along with the change of the task status; and display the display label (such as “manager review”) of the human task object and build a dynamic navigation link, the clicking of which will navigate to a related BO.

Key properties of an automation task object include:
Object ID;
Object status, including Inactive, Running, Finished and Exception;
Displayed object name; and
Input/output BO.

Dynamic/automatic visualization rules of an automation task object include:
Dynamically change the picture of the object at runtime according to the object status, such as by using default or pre-defined pictures; and
Dynamically build and display a navigation link and a display label to a related BO, etc.

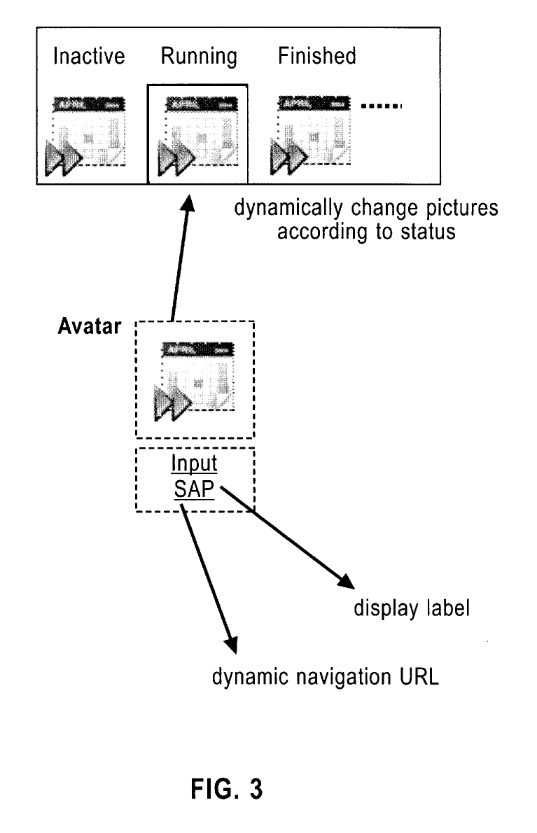

FIG. 3 shows an exemplary automation task object named Avatar and its display manner. As shown in the figure, the display manner of the exemplary automation task object is to: display the name of the automation task object (such as Avatar) and its icon which will change according to the status of the automation task object (such as “Inactive”, “Running” and “Finished”); and display the display label (such as “Input SAP”) of the automation task object and build a dynamic navigation link, the clicking of which will navigate to a related BO.

The key properties of a sub-process object include:
Object ID;
Object status, including Inactive, Running, Finished and Exception;
Displayed object name;
Input/output BO; and
Sub-process template/instance ID list.

Dynamic/automation visualization rules of the sub-process object include:
Dynamically change the picture of the object at runtime according to the object status, such as by using default or pre-defined pictures;
Dynamically build and display a navigation link and a display label to a related BO, etc; and
Dynamically display a sub-process instance list and a monitoring view generated for the sub-process instance.

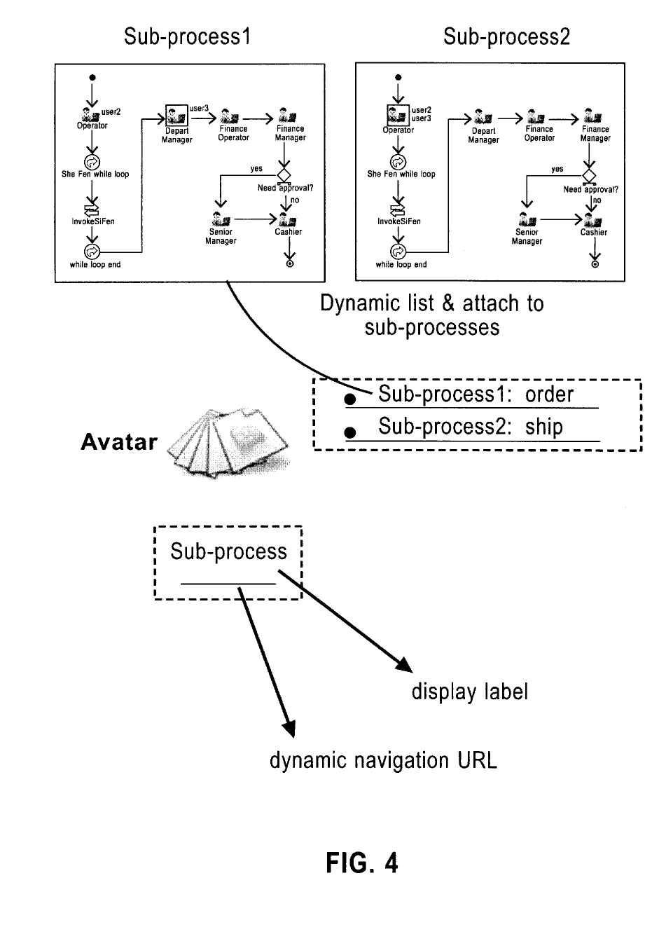

FIG. 4 shows an exemplary sub-process object named Avatar and its display manner. As shown in the figure, the display manner of the exemplary sub-process task object is to: display the name of the sub-process object (such as Avatar) and its label which will change according to the status of the sub-process object (such as “Inactive”, “Running”, “Finished” and “Exception”); and display the display label (such as “sub-process”) of the sub-process object and build a dynamic navigation link, the clicking of which will navigate to a related BO. In addition, a link to the sub-process list is displayed.

Key properties of a BO include:
Object ID;
Data source (from the current process or a task); and
Displayed object name.

Dynamic/automatic visualization rules of the BO include:
Dynamically associate the BO with a link (such as a link associated with the above monitoring object), thus clicking the link will display the BO, or just put the BO in any place of the generated monitoring view described below;
Dynamically display the BO in multiple formats such as picture, table, map or other styles; and
Dynamically build a navigation link and display label, etc.

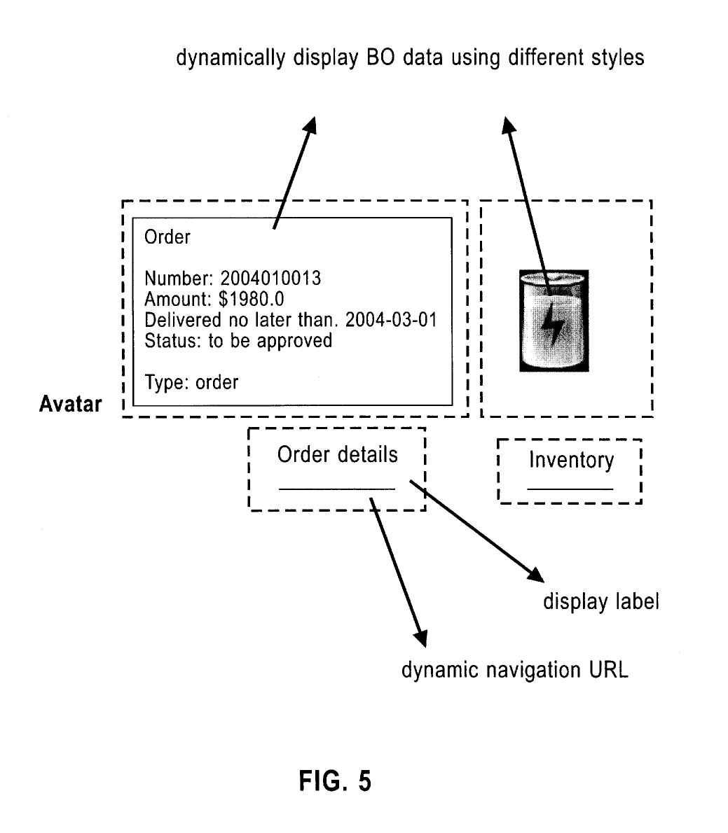

FIG. 5 shows an exemplary BO named Avatar and its display manner. As shown in the figure, the display manner of the exemplary BO is to: display the name of the BO object (such as Avatar); dynamically display the data of the BO in various styles such as table and map, etc.; and display the display label (such as “detail order” and “inventory”) of the BO and build a dynamic navigation link, the clicking of which will navigate to a related BO.

Key properties of a link object include:
Object ID;
Object status, including Inactive, Active, Finished, etc.;
Displayed object name; and
Associated BO.

Dynamic or automatic visualization rules of the link object include:
Dynamically change the line style/color of the link at runtime according to the object status, such as by using default or pre-defined line styles/colors; and
Dynamically display an associated BO in a picture or other styles.

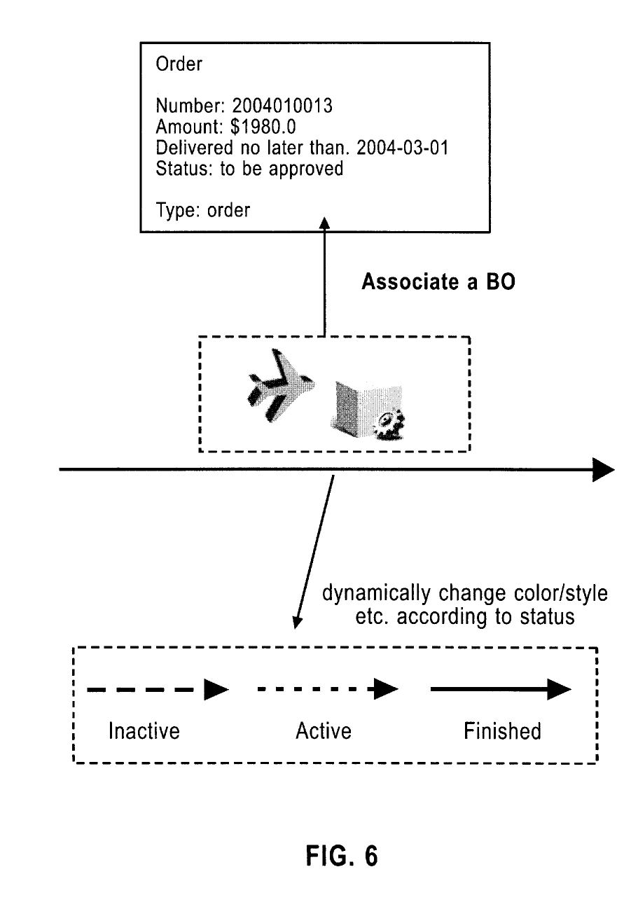

FIG. 6 shows an exemplary link object named Avatar and its display manner. As shown in the figure, the display manner of the exemplary link object is to: display the name of the link object (such as Avatar); dynamically display a graphic of the link object in different colors/styles, etc. according to the link object status; and display the picture of a BO associated therewith, etc.

Key properties of a logic node object include:
Object ID;
Object type, including Decision, Parallel, While-Loop, John/Merge, etc.; and
Displayed object name.

Dynamic or automatic visualization rules of the logic node object include:
Dynamically change the picture/color/style of the logic node at runtime according to the object status, such as by using a default or pre-defined pictures/colors/styles, etc.

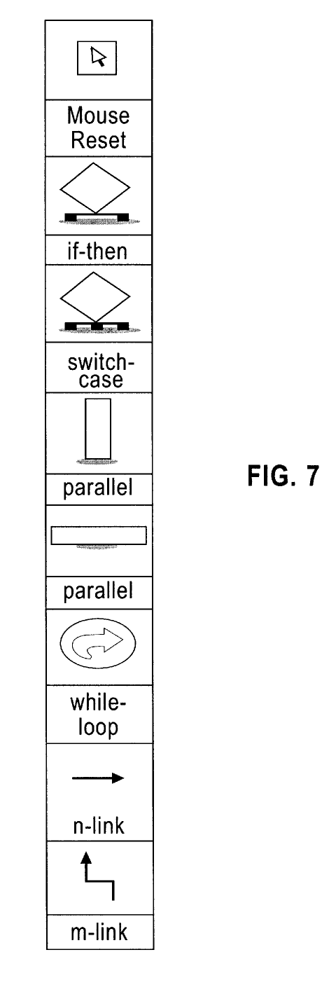

FIG. 7 shows various types of logic node objects and the display manner thereof. As shown in the figure, these logic node objects include if-then, switch-case, parallel, while-loop and etc.

The monitoring object model in the monitoring model according to an embodiment of the present invention is described above. Next, the relationship model and the visualization model in the monitoring model will be described below.

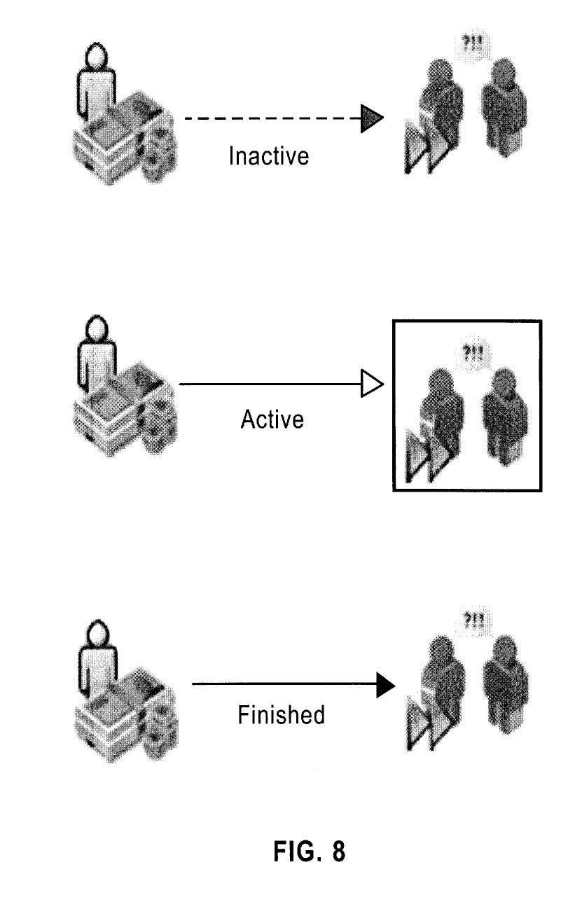

The relationship model in the monitoring model according to an embodiment of the present invention comprises the following three aspects:
The first is containment relationships and sequence relationships among monitoring objects. The containment relationship refers to a parent/children relationship, for example, a sub-process is the container for all other monitoring objects it contains. The sequence relationship refers to an incoming/outgoing relationship between monitoring objects, for example, if a human task object has an outgoing human task object, then the two human task objects have a sequence relationship.
The second is the status triggering or dependency relationships among monitoring objects. Status transition rules describe how the status of one object changes according to the dynamic changes of other objects' statuses. FIG. 8 shows an example of a dependency relationship between status transitions of monitoring objects. As shown in the figure, the status of a link object will depend on the statuses of human task objects as its incoming/outgoing nodes.
The third is data (BO) triggering/dependency relationships. Data item change rules describe how the value of a BO changes according to the dynamic changes of other objects' statuses/data.

A visual model in the monitoring model, according to an embodiment of the present invention, defines the visualization information for all the monitoring objects in the monitoring model. The visual model is composed of visual elements. Each visual element corresponds to a monitoring object and has the following key properties:
Reference to monitoring objects;
X-Y Layout: X/Y location, width, height information;
Link Layout: defining a series of bend points for the link object;
Status: defining associated graphic for each status, such as image file, animation, and svg.

See the above description of the visualization rules of the monitoring objects for other content of the visualization model.

### Apparatus for Generating a Monitoring View of an Executable Business Process

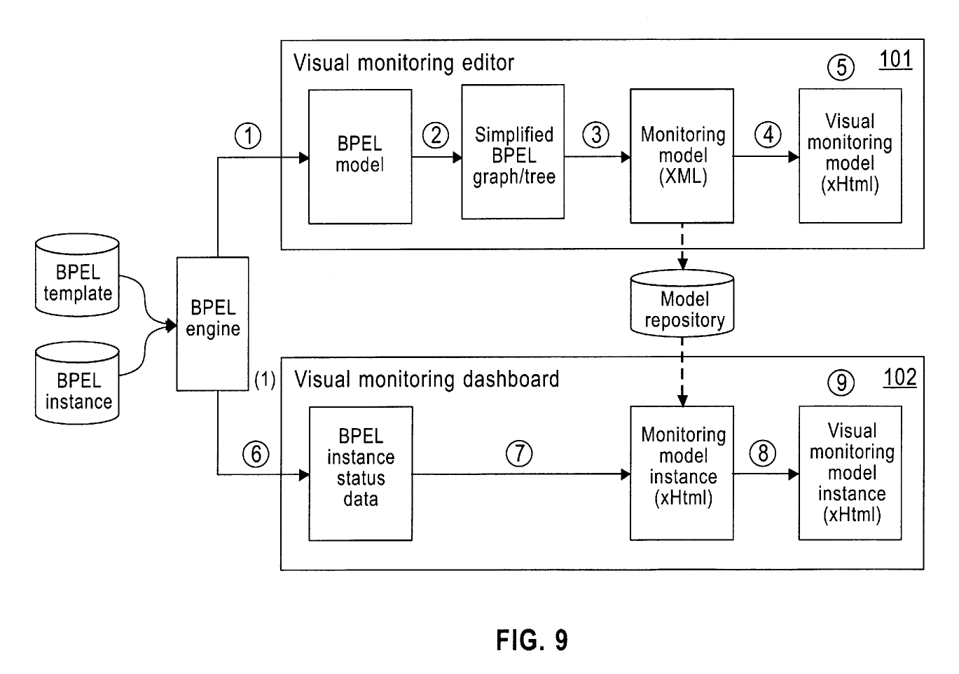

FIG. 9 shows an apparatus for generating a monitoring view of an executable business process according to an embodiment of the present invention. As shown in the figure, the apparatus comprises a monitoring model editor 101 and a visual monitoring dashboard 102.

The monitoring model editor 101 is used for the following operations:

A. It collects a BPEL model of a business process to be monitored from a BPEL template repository. This BPEL model is for example in the form of a XML document, and is generally of a tree structure. The monitoring model editor 101 can collect the BEPL model from a BPEL template repository by interacting with the BPEL engine, such as by invoking an API of the BPEL engine. Alternatively, the monitoring model editor 101 can directly collect the BPEL model of a deployed business process to be monitored from the BPEL template repository, or the BPEL model can be provided to the monitoring model editor 101 before being deployed.

B. After having obtained the BPEL model, the monitoring model editor 101 can extract a simplified BPEL model from the original BPEL model by filtering out those unused nodes or structures from the BPEL model while retaining main process logics.

In an exemplary embodiment of the present invention, the simplified BPEL model only contains all the task nodes, including invoke (i.e., automation task) nodes and human task nodes, in the original BPEL model, and connecting relationships among task nodes, while all the other nodes and relationships in the original BPEL model are filtered out.

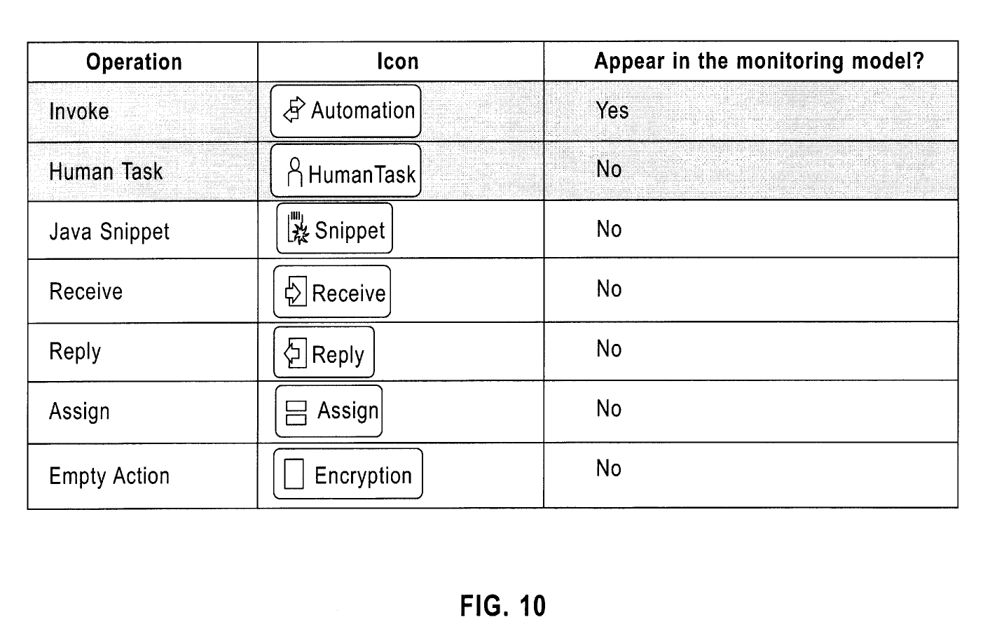

FIG. 10 shows whether various nodes in a BPEL model will appear in a monitoring model to be generated according to an embodiment of the present invention. As shown in the figure, automation task and human task nodes will be present in the monitoring model to be generated, while all other leaf nodes such as Java Snippet, Receive, Reply, Assign, Empty Action, etc. will be filtered out.

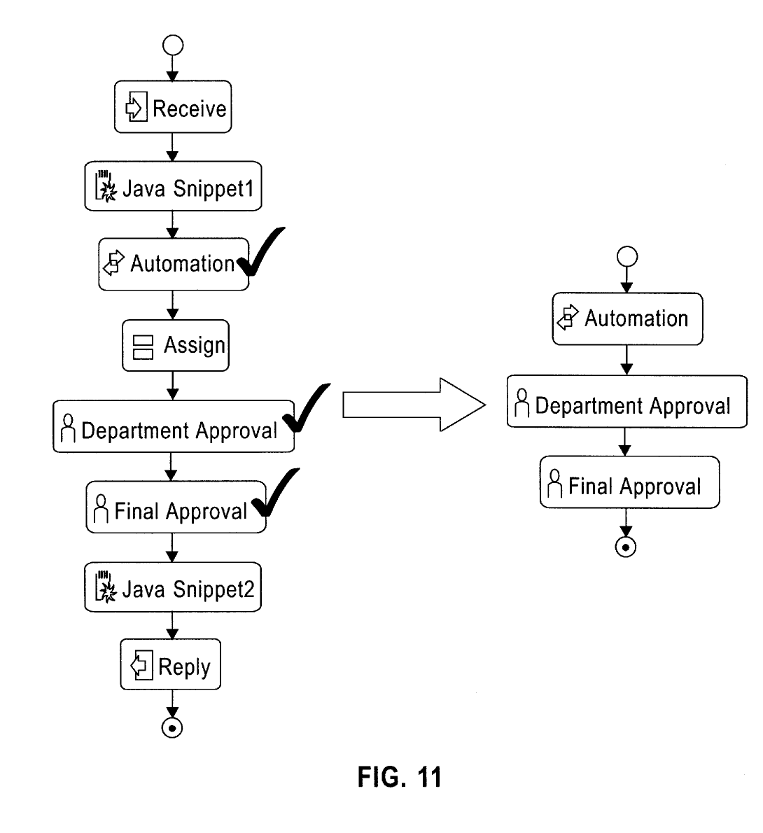

FIG. 11 shows an example of simplifying an exemplary BPEL model by using an embodiment of the present invention. As shown in the figure, in a plurality of nodes in the original BPEL model, only three nodes, Automation, Department Approval and Final Approval, are reserved while all the other nodes are filtered out. In the three retained nodes, the Automation node is an invoke node while the other two nodes are both human task nodes.

In addition to various leaf nodes, a complicated BPEL model further comprises various container nodes. For these container nodes, if they contain task nodes, then these task nodes will also be retained and extracted.

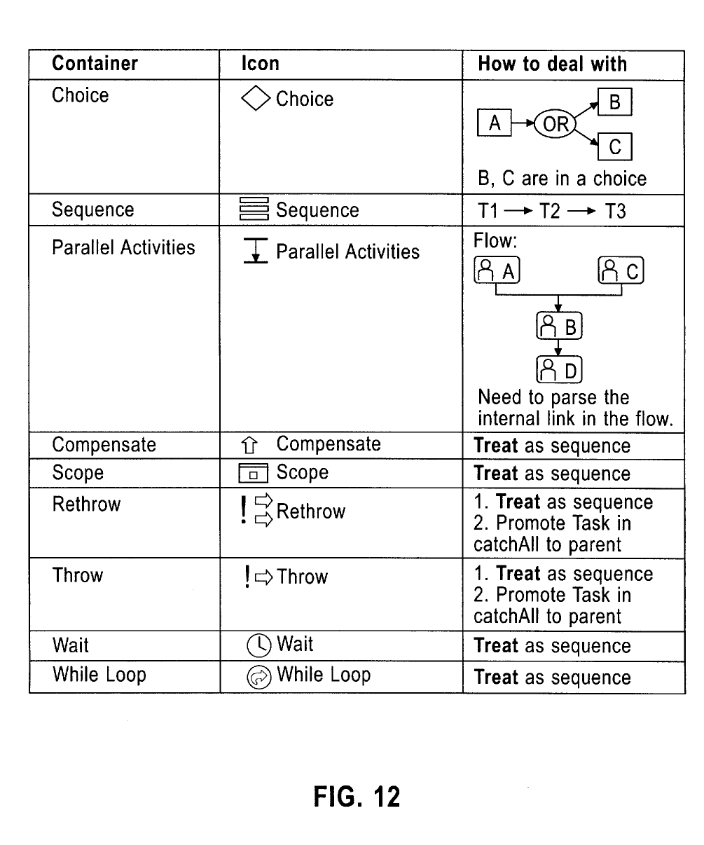

FIG. 12 shows a method for processing a container node containing task nodes in an original BPEL model according to an embodiment of the present invention. As shown in the figure, for a Choice container, it is simply deleted while only retaining the nodes it contains. For a Sequence container, the nodes therein and the sequence relationships thereof are retained. For Parallel Activities, it is needed to analyze the internal relationships of nodes in a flow to perform corresponding processing. For Compensate, Scope, Wait and While Loop containers, they are processed as Sequence, respectively. For Rethrow and Throw containers, they are processed as Sequence, respectively, and tasks in a catchAll are promoted to the parent node.

Specifically, the monitoring model editor 101 simplifies the BPEL model by using the following steps:
1. All the task nodes, including automation task nodes and human task nodes, in the BPEL model are searched for, and all the task nodes are ensured to be leaf nodes, that is, those task nodes that are not leaf nodes are changed into leaf nodes.

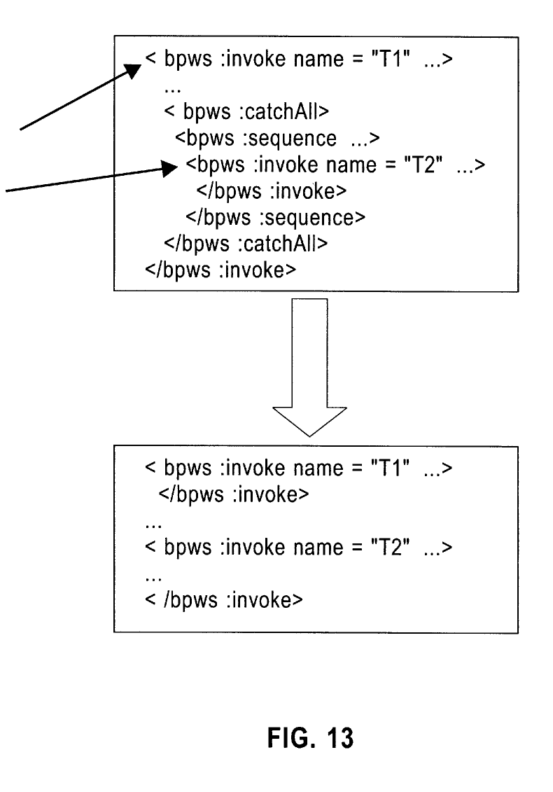

FIG. 13 shows an exemplary process of changing a task node, which is a non-leaf node represented by a piece of exemplary XML code, in an exemplary BPEL model into a leaf node according to an embodiment of the present invention. As shown in the figure, in an original BPEL model, task node T1 is a container node, and is changed into a leaf node according to a method of the embodiment of the present invention.
2. Task node paths are generated from the original BPEL model, and a new tree is generated using the paths, while all the other leaf nodes and container nodes having no task node in the BPEL model are filtered out.

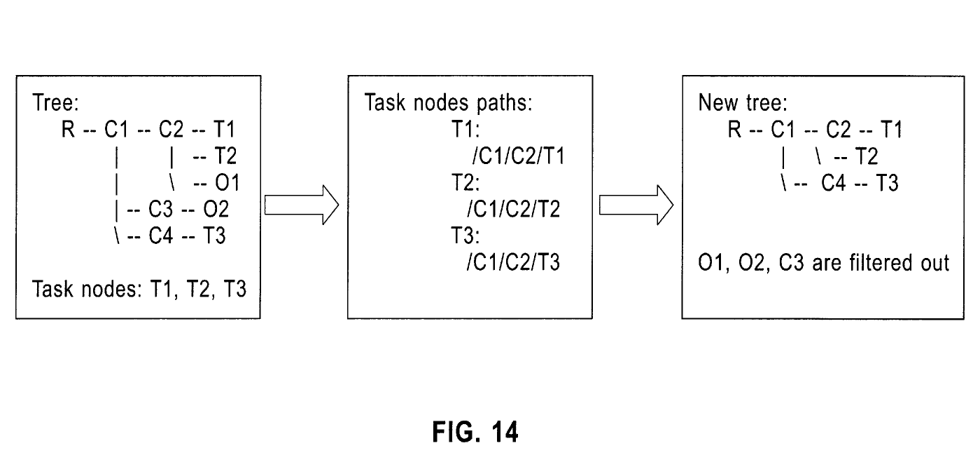

FIG. 14 shows an exemplary process of generating task node paths and a new tree from an exemplary BPEL model fragment according to an embodiment of the present invention. As shown in the figure, an original BPEL model tree contains three task nodes, T1, T2 and T3. Paths from a root node to the three task nodes are generated, and a new tree is generated based on the paths. The new tree only contains task nodes as leaf nodes and container nodes as parent nodes of these task nodes, while leaf nodes O1 and O2 as well as a container node C3 having no task node in the original BPEL model tress have been filtered out.
3. If a container node is the only child node of its parent node, then it is promoted to the position of its parent node and its parent node is deleted.

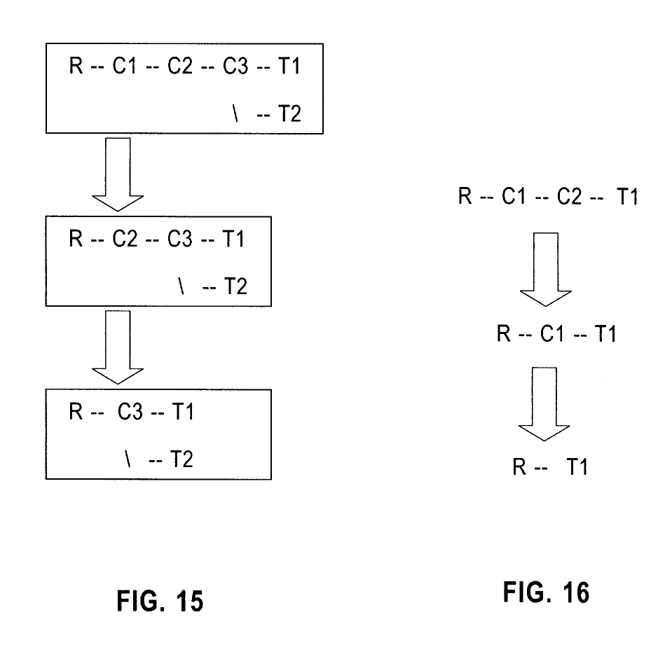

FIG. 15 shows an exemplary process of promoting a container node in an exemplary BPEL model tree fragment according to an embodiment of the present invention. As show in the figure, since a container node C2 in the model tree fragment is the only child node of its parent node C1, C2 is promoted to the position of C1, and C1 is deleted. Then, since a container node C3 is also the only child node of its parent node C2, C3 is promoted to C2 and C2 is deleted.
4. If a leaf node is the only node of its parent node, the leaf node is promoted to the position of its parent node, and its parent node is deleted.

FIG. 16 shows an exemplary process of promoting a leaf node in an exemplary BPEL model tree fragment according to an embodiment of the present invention. As shown in the figure, since a leaf node T1 is the only child node of its parent node C2, the leaf node T1 is promoted to the position of C2 and C2 is deleted. Then in its new parent node C1, the leaf node T1 is still the only child node, so the leaf node T1 is promoted to the position of C1 and C1 is deleted.
5. Nodes in a Sequence container and a Flow container are marked. The BPEL model tree generated after the above process will only contain task nodes and container nodes. The container node can be divided into two classes. One class is Sequence container nodes, the tasks in which are executed in sequence, so the step marks the task nodes in the Sequence container node as having a sequential execution relationship. Another class is Flow container nodes, the tasks in which are executed in parallel, so the step marks the task nodes in the Flow container node as having a parallel execution relationship.

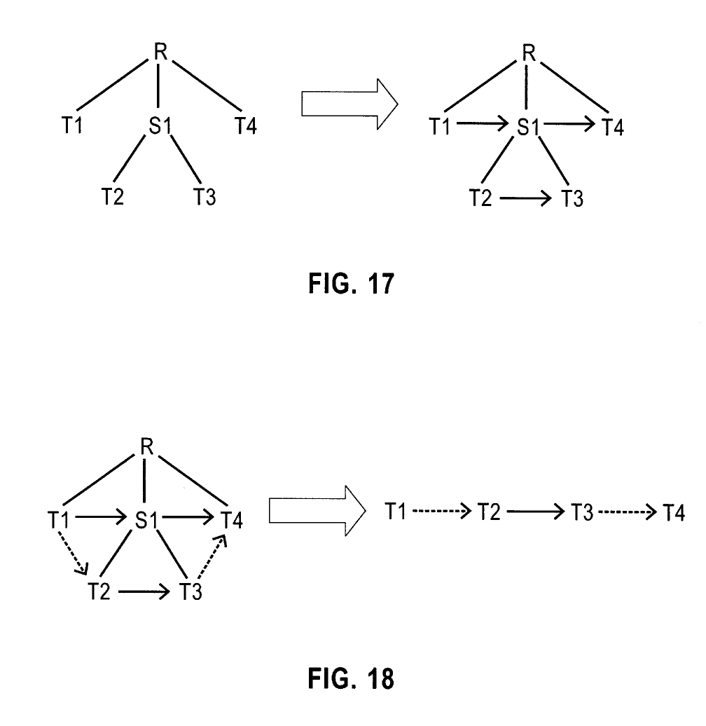

FIG. 17 shows an exemplary method for determining the task nodes in a Sequence container and a Flow container in an exemplary BPEL model tree formed through the simplification of the above steps according to an embodiment of the present invention.
6. The task nodes in a container obtain their source and target nodes from their parent container, that is, determines sequence relationships or connecting relationships with other nodes.

FIG. 18 shows an exemplary process of obtaining the source and target nodes of the task nodes in a container in an exemplary BPEL model tree formed through the simplification of the above steps via their parent container according to an embodiment of the present invention.

Thus, through the above simplification process, a simplified BPEL model is abstracted from the original BPEL model, and the simplified BPEL model will only contain task nodes and relationships among task nodes. It should be noted that the steps in the above process are only illustration, and are not limitations to the present invention, that is, the original BPEL model can be simplified using steps different from those described above.

C. The monitoring model editor 101 converts the simplified BPEL model formed through the above process into a monitoring model, which is generally in XML format. The monitoring model will contain human task nodes, automation nodes and connecting relationships among the task nodes.

D. The monitoring model editor 101 converts the generated monitoring model into xHTML format using a known method in the art, so as to form a visual monitoring model, and present it in the editor.

E. A user can edit the visual monitoring model in the monitoring model editor 101 for improvement. Of course, if the user is satisfied with the visual monitoring model as generated above, then the step can be omitted. The edition operation comprises: adding links to business objects into the monitoring model generated in the above steps according to a business view (for example, the link is added to a human task node or automation node needing the business object), adding logical nodes such as while, decision, fork, join or merge, and adding link nodes if necessary; and specifying and adjusting the display manner of the visual monitoring model, such as layout information of monitoring objects like positions and sizes, related icons, pictures, line styles and line widths, etc.

The above edition functions can be performed using a method known in the art, such as by establishing an edition interface in the monitoring model editor 101, and establishing some controls that can accomplish various editing operations in the edition interface.

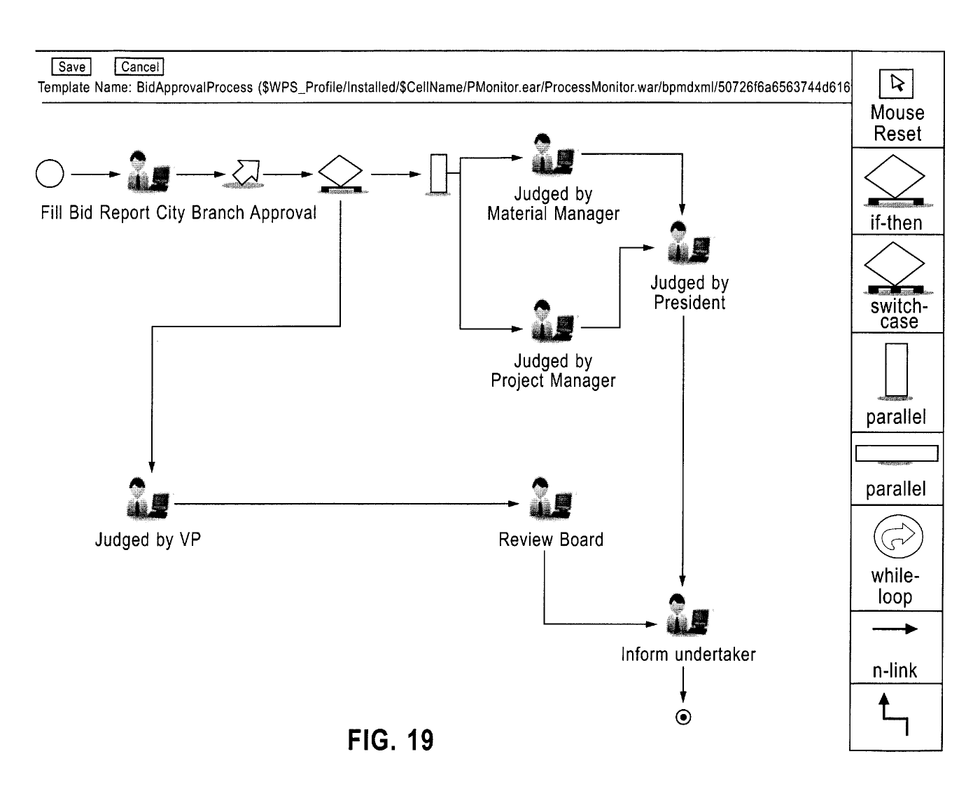

FIG. 19 shows a UI in which an editor of a visual monitoring model generated according to the above steps is shown according to an embodiment of the present invention. As shown in the figure, there are displayed on the right side of the UI of the editor controls for editing the monitoring model, which can be used to add logical and link nodes into the generated monitoring model.

F. The user can store the generated and/or edited monitoring model in a model repository, and can later retrieve the monitoring model from the model repository for re-edition or re-customization, such as changing the layout of a visual monitoring model, changing the appearance of monitoring objects, changing various links, and changing logical and connecting relationships, status dependency relationships and data dependency relations among various monitoring objects.

Returning to FIG. 9, the visual monitoring dashboard 102 in the apparatus for generating a monitoring view of an executable business process according to an embodiment of the present invention is used to perform the following operations:

G. Monitoring and collecting status data of a BPEL instance from a BPEL engine.

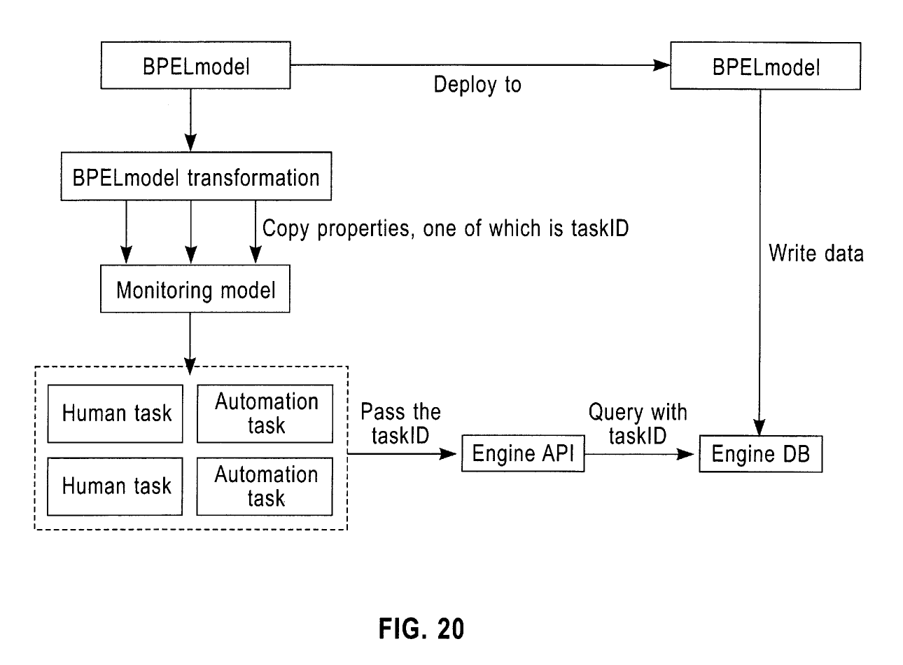

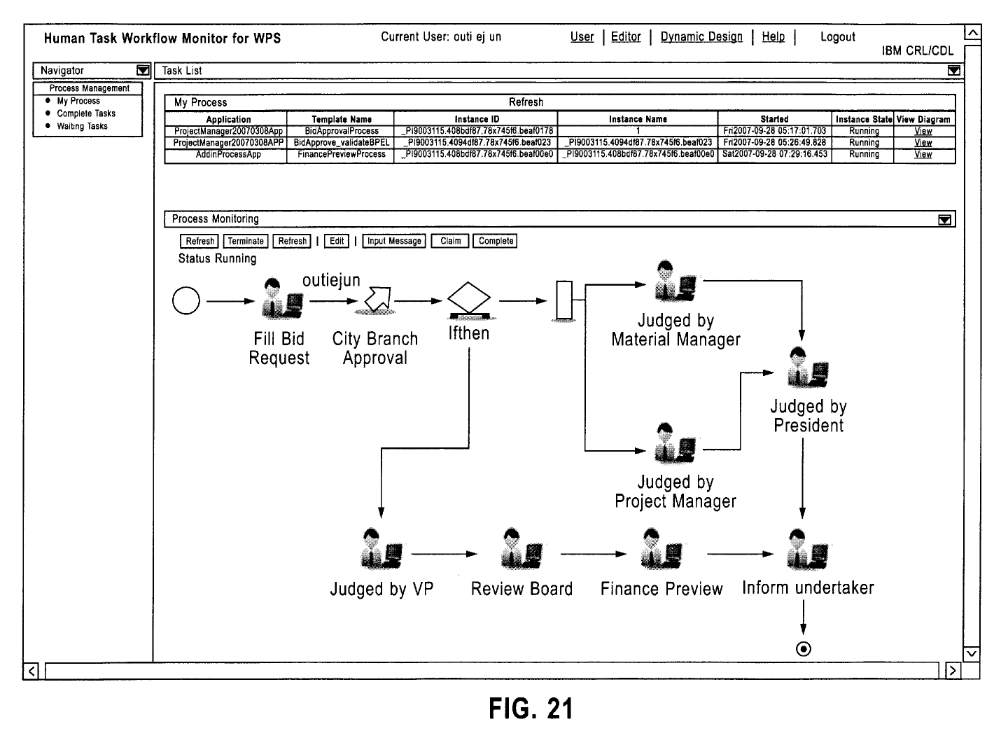

FIG. 20 shows a method for collecting status data of a BPEL instance from a BPEL engine according to an embodiment of the present invention. As shown in the figure, a BPEL model will be deployed to a BPEL engine for execution, and the BPEL engine will serialize process instances into an engine database. Before the BPEL model is deployed into the BPEL engine (or after the BPEL model is deployed into the BPEL engine), the monitoring model editor 101 in the apparatus for generating a monitoring view of an executable business process, according to an embodiment of the present invention, converts the BPEL model into a monitoring model by using the above process. As described above, during the conversion, the task ID properties of the nodes in the BPEL model will be copied into the monitoring model. Thereafter, by invoking the BPEL engine API, the visual monitoring dashboard 102 queries the engine database using task IDs in a monitoring model so as to obtain the status data of task objects having the task IDs and needed property data, as well as related business object data in the engine database.

H. A monitoring model instance is generated by combining the status data and the monitoring model generated in the above described process. In the monitoring model instance, the various monitoring objects in the monitoring model will obtain corresponding data statuses and property data, and implement the visualization model and the relationship model in the monitoring model.

For example, in the generated monitoring model instance, in addition to an object ID, display name and icon, and status, a human task object further has owners' names and contact information, such as IM/SMS/email/Phone Addresses, etc., as well as possibly links to related input/output BO data. Thus, by clicking the corresponding contact information, a notification mechanism such as phone, SMS, email and IM can be invoked, so as to provide collaboration among business users; and by clicking a link to a BO, corresponding BO data (which is obtained by invoking an API of the BPEL engine, for example) can be displayed. The icon as well as the owners' names, contact information, etc. of the human task object will change dynamically according to changes of its status.

For another example, in the generated monitoring model instance, in addition to an object ID, display name and icon, and status, an automation task object may further obtain a link to related input/output BO data. Those automation task objects containing sub-processes further have the list of the contained sub-process templates or instance IDs; clicking a certain sub-process template or an instance ID in the sub-process template or the instance ID list will invoke a corresponding BPEL engine API to obtain and display a sub-process monitoring model. The icon of the automation task object will change dynamically according to changes of its status.

For still another example, in the generated monitoring model instance, in addition to an object ID and display name, a BO further has an indication of the data source of the BO, as well as possibly links to other related BOs. The BO can be displayed dynamically in a plurality of formats such as a picture, table, image, etc. In addition, the value of the BO can be dynamically changed according to the statuses of other monitoring objects or changes of data of other BOs.

For yet another example, in the generated monitoring model instance, in addition to an object ID, display name and status, a link object further possibly has related BOs. The icon of the link object, such as its line style and color, etc., can change dynamically according to changes of its status, and its related BOs can be displayed in pictures or other styles. The status of the link object can change dynamically according to changes of other incoming and outgoing monitoring objects.

For further example, in the generated monitoring model instance, a logical node will have an object ID, object type, display icon and name, and status. The icon of the logical node object will change dynamically according to changes of its status. And the status of the logical node object will change dynamically according to changes of the statuses of the task nodes it contains.

I. The generated monitoring object model in XML format is converted to an xHTML format, thus forming a visual monitoring model instance, which is presented to an end business user, so that the user can monitor the running BPEL business process. In a UI of the monitoring object model instance, there will be displayed the names and icons of human tasks and automations tasks, and sequential execution relationships and parallel execution relationships as well as various logical relationships among these tasks, so as to display graphically the statuses of these tasks, which change dynamically and automatically, and links of these tasks to business objects. By clicking the links, corresponding BO data can be accessed and displayed, etc.

In addition, using the UI of the visual monitoring model instance, the end business user can perform some management functions and execution functions on the business process instance, including suspension and termination of the business process instance, transferring of the owner of a human task, and task claim and completion. These functions are implemented by providing in the UI of the visual monitoring model instance necessary buttons, upon clicking which, a corresponding API provided by the process engine can be invoked.

FIG. 21 shows an example of a UI of a monitoring object model instance generated by the above process according to an embodiment of the present invention.

In the foregoing is described an apparatus for generating a monitoring view of an executable business process according to an embodiment of the present invention. It is obvious for a person skilled in the art to also derive from the above description a method for generating a monitoring view of an executable business process according to the embodiment of the present invention, since the operations performed by the above described apparatus correspond to the steps in the method, respectively.

It should be noted that the above descriptions are only illustrations, and not limitation to the present invention. For example, although in the above description it is the monitoring model editor 101 and the visual monitoring dashboard 102 that perform the above operations, in other embodiments of the present invention, the operations can also be performed by components contained in the monitoring model editor 101 and the visual monitoring dashboard 102, respectively. For example, the monitoring model editor 101 may comprise a BPEL model extractor for extracting a BPEL model from the BPEL engine, a BPEL model simplifier for simplifying the BPEL model, a monitoring model generator for generating a monitoring model from a simplified BPEL model, a monitoring model presenter for converting the monitoring model into a visual monitoring model and presenting the visual monitoring model, and a monitoring model manager for editing and storing the monitoring model and loading the stored monitoring model. The visual monitoring dashboard 102 may comprise a status data collector for collecting status data from a BPEL engine, a monitoring model instance generator for generating a monitoring model instance based on the status data and the monitoring model, a visual monitoring model instance generator for converting a monitoring model instance into a visual monitoring model instance, and a business process monitoring manager for presenting a monitoring model instance, and monitoring and managing the business process through the UI of the monitoring model instance, etc.

The present invention can be realized in hardware, software or a combination thereof. The present invention can be realized in a computer system in a centralized manner, or in a distributed manner, in which, different elements are distributed among interconnected computer systems. Any computer system or other apparatus suitable for carrying out the methods described herein is applicable. Preferably, the present invention is realized by a combination of computer software and general purpose computer hardware, in which, the computer program, when being loaded and executed, controls the computer system to make it carry out the method of the present invention, and constitute the apparatus of the present invention.

The present invention can also be embodied in a computer program product, which comprises all the features enabling the method described herein to be implemented, and which, when being loaded into the computer system, can carry out these methods.

While the present invention is shown and described with reference to the preferred embodiments particularly, a person skilled in the art can understand that various changes in form and detail can be made thereto without departing from the spirit and scope of the present invention.

1. A method for generating a monitoring view of an executable business process, comprising the steps of:
obtaining a business process model from an executable business process template;
generating a business process monitoring model from the business process model;
obtaining status data of a business process instance from a business process engine;
generating a business process monitoring model instance by combining the status data with the business process monitoring model; and
presenting the business process monitoring model instance as a monitoring view through which a user monitors a running business process instance.

2. The method according to claim 1, wherein the step of generating a business process monitoring model from the business process model comprises the sub-steps of:
generating a simplified business process model by retaining main business logics in the business process model and filtering out other nodes and structures; and
converting the simplified business process model into the business process monitoring model.

3. The method according to claim 1, further comprising the steps of:
presenting visually the generated business process monitoring model in an editor; and
editing by a user the business process monitoring model presented visually in the editor for improvement.

4. The method according to claim 1, further comprising the step of:
storing the generated business process monitoring model in a repository so as to further generate the monitoring model instance there from.

5. The method according to claim 3, further comprising the step of:
storing the edited business process monitoring model in a repository so as to further edit the monitoring model instance there from.

6. The method according to claim 1, wherein the business process engine is a Business Process Execution Language (BPEL) engine, and the business process template is a BPEL template.

7. The method according to claim 1, wherein the business process monitoring model comprises a monitoring object model, a relationship model and a visualization model.

8. The method according to claim 7, wherein the monitoring object model comprises at least one monitoring object selected from the group consisting of: human task, automation task, sub-process, business object, link nodes, and logical nodes.

9. The method according to claim 7, wherein the monitoring object model comprises task IDs obtained from the business process template, and the step of obtaining status data of a business process instance from a business process engine comprises querying the status data of the tasks via a process engine API according to the task IDs.

10. The method according to claim 7, wherein the relationship model comprises containment or sequence relationships among monitoring objects, status triggering/dependency relationships among monitoring objects and data triggering/dependency relationships among monitoring objects.

11. The method according to claim 1, further comprising the step of, when necessary, before deploying the business process template in the business process engine, adding in the business process template annotations facilitating the generation of the business process monitoring model there from.

12. The method according to claim 1, further comprising at least one step selected from the group consisting of: managing a running business process instance and conducting collaboration among business users through the monitoring view.

13. An apparatus for generating a monitoring view of an executable business process, comprising:
a monitoring model editor which is configured to
obtain a business process model from an executable business process template, and
generate a business process monitoring model from the business process model; and
a visual monitoring dashboard which is configured to
obtain status data of a business process instance from a business process engine,
generate a business process monitoring model instance by combining the status data with the business process monitoring model, and
present the business process monitoring model instance as a monitoring view through which a user monitors a running business process instance.

14. The apparatus according to claim 13, wherein the monitoring model editor configured to generate a business process monitoring model is further configured to:
generate a simplified business process model by retaining main business logics in the business process model and filtering out other nodes and structures; and
convert the simplified business process model into the business process monitoring model.

15. The apparatus according to claim 13, wherein the monitoring model editor is further configured to:
present visually the generated business process monitoring model in an editor; and
allow a user to edit the business process monitoring model presented visually in the editor for improvement.

16. The apparatus according to claim 13, wherein the monitoring model editor is further configured to:
store the generated business process monitoring model in a repository so as to further edit it or generate the monitoring model instance there from by the visual monitoring dashboard.

17. The apparatus according to claim 13, wherein the business process engine is a BPEL engine, and the business process template is a BPEL template.

18. The apparatus according to claim 13, wherein the business process monitoring model comprises a monitoring object model, a relationship model and a visualization model.

19. The apparatus according to claim 18, wherein the monitoring object model comprises at least one monitoring object selected from the group consisting of: human task, automation task, sub-process, business object, link nodes and logical nodes.

20. The apparatus according to claim 18, wherein the monitoring object model comprises task IDs obtained from the business process template, and the visual monitoring dashboard configured to obtain status data of a business process instance from a business process engine is further configured to query the status data of the tasks via a process engine API according to the task IDs.

21. The apparatus according to claim 18, wherein the relationship model comprises containment or sequence relationships among monitoring objects, status triggering/dependency relationships among monitoring objects and data triggering/dependency relationships among monitoring objects.

22. The apparatus according to claim 13, wherein, when necessary, before being deployed in the business process engine, the business process template is added annotations facilitating the generation of the business process monitoring model there from.

23. The apparatus according to claim 13, wherein the visual monitoring dashboard is further configured to manage a running business process instance, conduct collaboration among business users through the monitoring view, or both.
